(19) United States
(12) Patent Application Publication
(10) Pub. No.: US 2009/0143047 A1
(43) Pub. Date: Jun. 4, 2009

(54) Method and system for mobile personal emergency response

(76) Inventors: William D. Hays, Jackson, MS (US); Owen P. Lalor, Ridgeland, MS (US)

Correspondence Address: KING & SPALDING, 1180 PEACHTREE STREET , NE, ATLANTA, GA, 30309-3521, US

(21) Appl. No.: 12/290,355

(22) Filed: Oct. 30, 2008

Related U.S. Application Data
(60) Provisional application No. 60/984,083, filed on Oct. 31, 2007.
(60) Provisional application No. 60/986,290, filed on Nov. 8, 2007.
(60) Provisional application No. 61/023,763, filed on Jan. 25, 2008.

(51) Int. Cl. H04M 11/04

(52) U.S. Cl. 455/404.2

(57) ABSTRACT

Advanced mobile personal emergency response systems. An activator worn or carried by a user sends a medical or security alert to a portable mobile base station. The mobile base station transmits the alert to trained operators at a call center. An operator conducts one-way or two-way voice communication through the activator with the user during the emergency response. The mobile base station transmits current location coordinates to the operator, including the last known good coordinates when the user enters an area where the external location system does not work. Emergency responders can use a beacon function to locate a lost activator if they find the mobile base station. A voice quality self-test function is useful for increasing the user's confidence that the system is working. Users can employ a finder function to find one of the activator or mobile base station when the other device is available.

The present application claims priority under 35 U.S.C. 119(e) to U.S. Provisional Patent No. 60/984,083 filed Oct. 31, 2007, U.S. Provisional Patent Application No. 60/986,290 filed Nov. 8, 2007, and U.S. Provisional Patent Application No. 61/023,763 filed Jan. 25, 2008, the contents of all three of which are hereby incorporated by reference in their entirety.

### FIELD OF INVENTION

The invention relates generally to advanced mobile personal emergency response systems (PERS), and more particularly to a mobile PERS for establishing hands-free voice communication from an activator device through a mobile base station to a call center operator to summon assistance.

### BACKGROUND

Various systems exist for personal emergency response systems in both the medical and security applications. In the medical application, existing systems include medical alert wire line systems and monitoring services. They operate using a “panic button” that can communicate wirelessly with a speakerphone and autodialer at a distance of 200-600 feet. To be heard, the user must stay within the range of the speakerphone. The user summons help by pressing the panic button which transmits an alert signal to the stationary autodialer. The autodialer calls a monitoring facility. The user must remain within signaling distance of the autodialer for the system to work.

These systems put several limitations on the user. First, the system cannot be used in mobile or fixed portable fashion so the user's mobility is limited. Next, voice communication between the user and the monitoring facility is only possible when the user is close enough to the speakerphone for the user's voice to carry to the speakerphone and for the user to hear the output of the speakerphone. Also, the only way for the user to test the system is by placing a call to the monitoring service. This ties up valuable operator time, and raises the risk that the user will not test the system to avoid “bothering” the operators. Finally, existing systems do not have the capability to locate a user who wanders out of the range of the speakerphone and autodialer.

At least two systems are used in the personal security environment—mobile phones and fixed location alarm buttons. Individuals such as real estate agents who meet unfamiliar people in unfamiliar places often rely on their mobile phone for security. Professionally, these individuals must act with confidence to be successful. If a stranger appears threatening, but has not broken any laws, it may be inappropriate to call the police. Relying on a mobile phone in these potentially threatening circumstances places several limitations on the user. The options when using a mobile phone are to ignore the situation or to risk raising a false alarm. If the stranger is intent on committing a crime, using a mobile phone may escalate the danger. The stranger may remove the mobile phone, leaving the user with no method of communication with the outside world. If the mobile phone is removed from the user, and the stranger abducts the user to a different location, there is no way to trace the user to the new location.

With a fixed location personal security alarm system, when a threat occurs the user presses a button to summon a responder. These systems place several limitations on the user. First, there is no voice communication with the responder, who therefore has no information as to the user's situation apart from the fact that there is an alarm. Second, as with the mobile phone, the user's only options are to ignore the situation or risk raising a false alarm. Finally, the system only works when the user is where the alarm is located; it provides no assistance to a user who has been abducted or is not at that particular location. It therefore is of no use to the professional who must meet unfamiliar people in unfamiliar places.

While existing devices may be suitable for the purposes they address, they fail to enable users in either a fixed or a non-fixed environment to contact trained operators with the push of a button on a user-accessed device that automatically provides hands-free voice communication and, in the case of a non-fixed environment, location information. Nor are they suitable to provide automatic assurance that the system is operating properly.

Therefore, a need exists in the art for providing voice communications and any necessary location information through a mobile device that allows the user to summon assistance with confidence.

### SUMMARY OF THE INVENTION

The invention provides voice communications and user location information through a user-accessed device operating in conjunction with a mobile base station.

The user typically wears or carries an activator in support of an emergency response function. The activator communicates voice and data wirelessly to a portable mobile base station. The portable mobile base station can be remotely located from the user. The activator and mobile base station can complete successful communications without a requirement for the user to be proximate to the base station.

In one aspect, both the activator and the mobile base station can interface with an external location system. In another aspect, the mobile base station alone can interface with an external location system. The mobile base station stores in memory the last obtained location coordinates of the activator, the mobile base station, or both. If the user enters an area where neither device can communicate with the external location system, the mobile base station stores the last known good coordinates.

The mobile base station relays voice and data information from the activator through a communications network to trained operators at a call center. The operators are provided predetermined emergency response parameters from a call center database for each user based on type of emergency, location and time. The call center can also contain equipment for conducting voice quality tests and recording user voice verification records.

The user can initiate an emergency response by signaling the mobile base station through the activator. For one aspect of the invention, the mobile base station assembles location, user ID and type of emergency information and transmits it to the call center. The call is routed to a selected operator along with the predetermined emergency response parameters for the user. The operator then has the ability to conduct either one-way or two-way voice communications with the user throughout the entire emergency response, providing confidence and comfort to the user.

For a medical alert, the operator can conduct two-way voice communications with the user. For a security alert where two-way voice communication might endanger the user, the operator and emergency responders can hear what is transpiring at the user's location using one-way voice communication. As an additional check against false alarms, the user can speak a prerecorded signal phrase to verify that a security emergency is in progress.

If upon arriving at the location coordinates the emergency responders can locate the mobile base station but not the user, a local beacon function in the mobile base station may be used to locate the activator. Alternatively, an audible signal function may be used to locate the activator as described below.

The user can conduct a voice quality self-test through the activator to gain a high degree of confidence that the system is working as required. After initiating the test, the user speaks a specially selected pre-determined phrase into the activator. The phrase input is transmitted wirelessly from the activator to the mobile base station. The mobile base station transmits the phrase over the communications network to the call center. At the call center, the phrase input is recorded and optionally measured using voice quality techniques. The phrase is then transmitted back to the mobile base station over the communications network. The mobile base station then transmits the phrase to the activator for user assessment. As an option, an objective quality score may be transmitted back to the user as well.

The user can initiate a session through the activator, the mobile base station, a mobile phone or a landline phone where the user will speak a security phrase that will be used during an actual security emergency for verification purposes. The phrase will be recorded at the call center and will be made a part of the user's information in the call center database. In the event of an actual emergency, the user will remember and speak the phrase. The user information records displayed to the call center operator will include the existence of the security phrase, which the operator can play at any time to match and verify that the security emergency is real.

An additional convenience is that either the activator or mobile base station may be used to locate the other device when one is lost (for example, when a user misplaces one of the devices in her car). Pressing a finder button on one device generates an audio alert on the other device.

Additional aspects, features, and advantages of the invention will become apparent to those skilled in the art upon consideration of the following detailed description of illustrated embodiments exemplifying the best mode of carrying out the invention as presently perceived.

### BRIEF DESCRIPTION OF THE DRAWINGS

FIG. 1 is a block diagram depicting a system for providing a mobile personal emergency response in accordance with an exemplary embodiment of the invention.

FIG. 2 is a block diagram for an activator used in a mobile personal emergency response system in accordance with an exemplary embodiment of the invention.

FIG. 3 is a block diagram for a mobile base station used in a mobile personal emergency response system in accordance with an exemplary embodiment of the invention.

FIG. 4 is a block diagram for the call center interfaces used in a mobile personal emergency response system in accordance with an exemplary embodiment of the invention.

FIG. 5 is a flow chart depicting a method for providing a personal network emergency response in accordance with an exemplary embodiment of the invention.

FIGS. 6a and 6b are flow charts depicting a method for providing a mobile personal emergency response in accordance with an exemplary embodiment of the invention.

FIG. 7 is a flow chart depicting a method for communicating between the call center operator and an activator user in accordance with an exemplary embodiment of the invention.

FIG. 8 is a flow chart depicting a method for locating the activator through a local beacon in accordance with an exemplary embodiment of the invention.

FIG. 9 is a flow chart depicting a method for activator voice quality self-test in accordance with an exemplary embodiment of the invention.

FIG. 10 is a flow chart depicting a method for security phrase verification of a security alert in accordance with an exemplary embodiment of the invention.

FIG. 11 is a flow chart depicting a method for locating one of the activator or mobile base station through a finder function using the other of the activator or mobile base station in accordance with an exemplary embodiment of the invention.

### DETAILED DESCRIPTION OF EXEMPLARY EMBODIMENTS

The invention supports the valuable function of a mobile personal emergency response by providing voice communications and user location information through a user-accessed device operating in conjunction with a mobile base station.

Turning now to the drawings, in which like numerals indicate like elements throughout the figures, exemplary embodiments of the invention are described in detail.

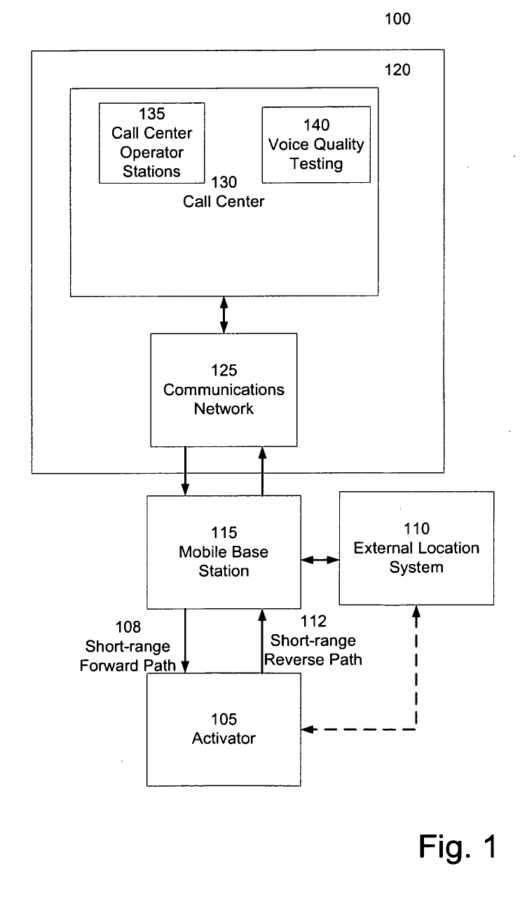

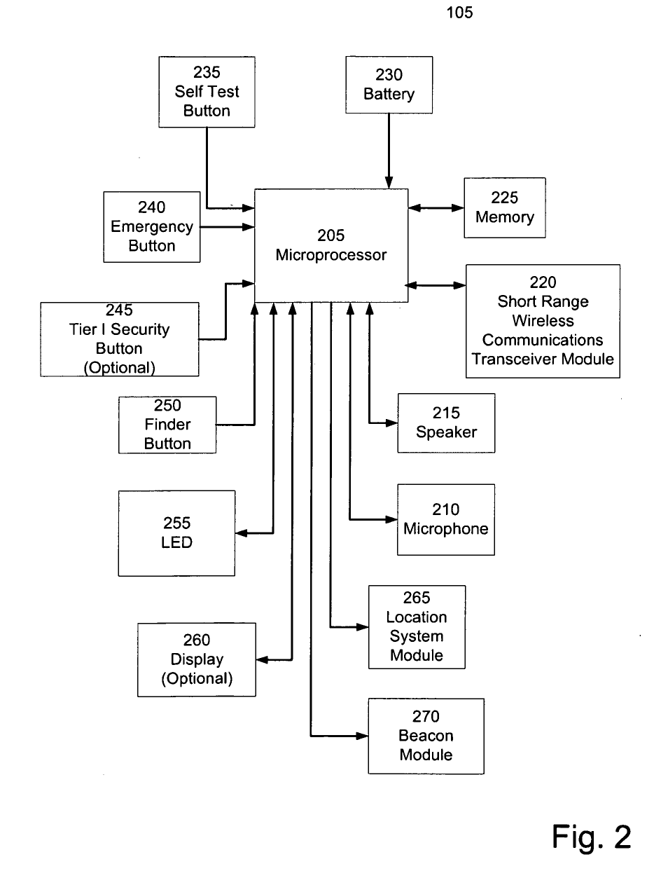

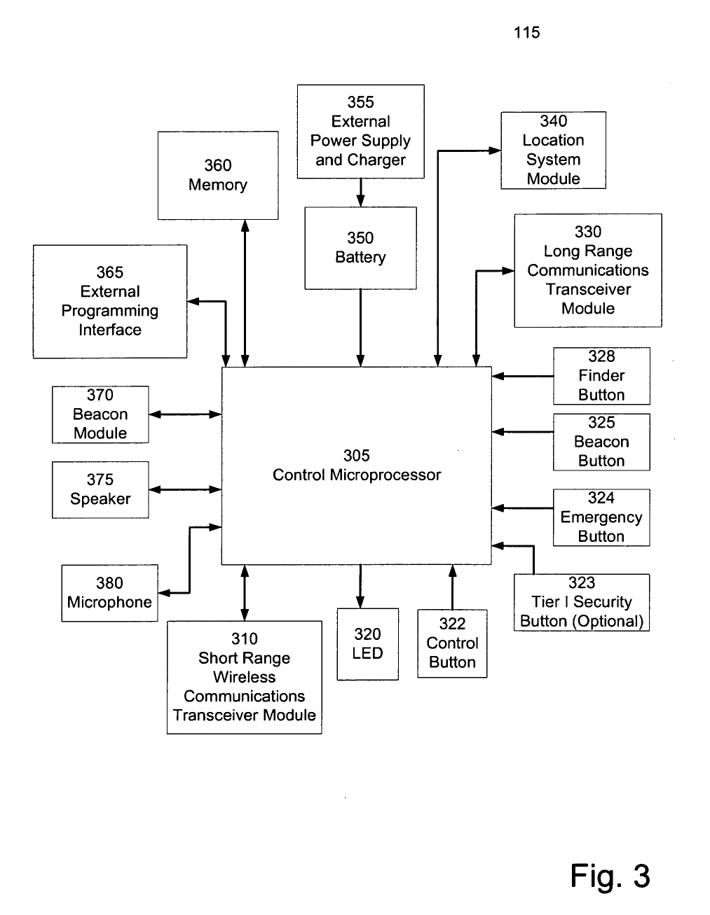

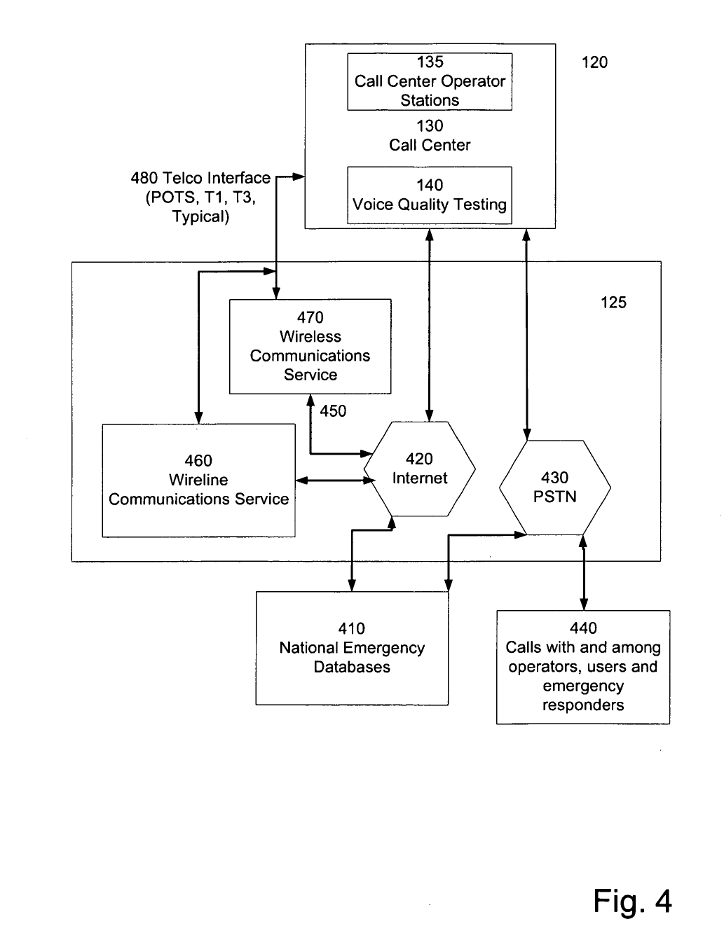

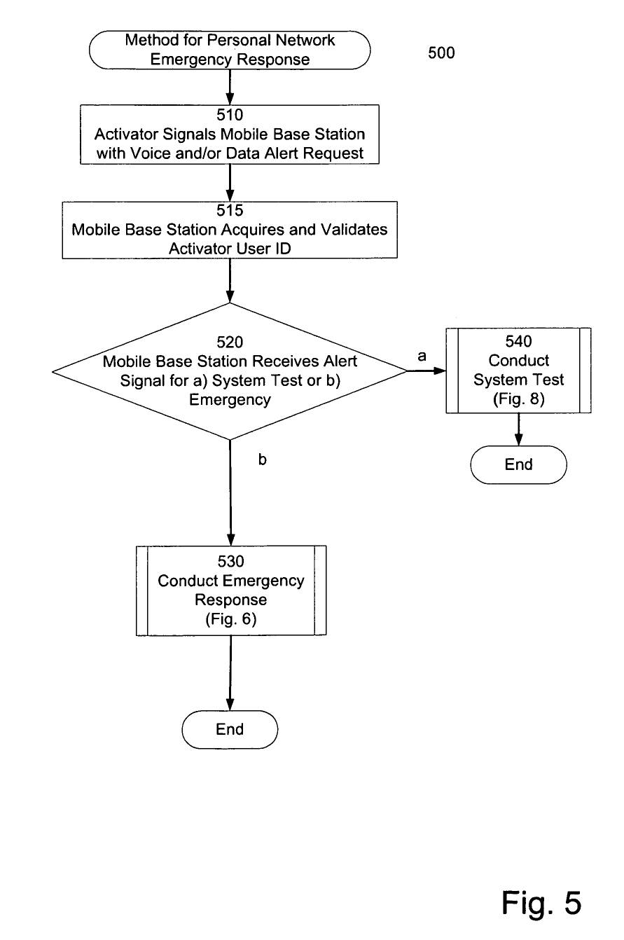

FIG. 1 is a block diagram depicting a system 100 for providing a mobile personal emergency response in accordance with certain exemplary embodiments. An activator 105, described more fully in FIG. 2 below, communicates bi-directionally with a mobile base station 115, described more fully in FIG. 3 below. Communication from the mobile base station 115 to the activator 105 occurs through a short-range forward path 108. Communication from the activator 105 to the mobile base station 115 occurs through a short-range reverse path 112. The short-range distance between the activator 105 and the mobile base station 115 is typically one kilometer or less. The mobile base station 115 connects wirelessly with an external location system 110. The activator 105 may connect with the external location system 110 as well. The mobile base station 115 communicates bi-directionally through a communications network 125 to a call center 130. Communication from the call center 130 to the mobile base station 115 occurs through a long-range forward path. Communication from the mobile base station 115 to the call center 130 occurs through a long-range reverse path. The long-range distance between the mobile base station and the emergency call center is typically more than one kilometer. The call center 130 includes state-of-the art call center operator stations 135 and the capability to test the quality of voice messages 140. The external components 120 are described more fully in FIG. 4. The system 100 is described below with reference to the methods illustrated in FIGS. 5-11.

FIG. 2 is a block diagram illustrating the activator 105. The activator 105 is a small electronics unit, which may be shaped like a pendant designed to be worn around the neck or pinned to the user, or it may be a wristband unit designed to be worn like a watch or attached to a belt or other accessory. In one embodiment, the activator 105 has enclosure dimensions of approximately 1.25″×1.5″. The activator 105 contains a microprocessor 205 controlling the test, location and calling functions. The microprocessor 205 generates a specific user ID employed in methods 530, 540, 677, 688, and 752.

The activator 105 will initiate the process of test, location or calling for help by signaling the mobile base station 115 through the short-range wireless communications transceiver module 220. In addition, the activator 105 contains a microphone 210 for voice communication with the call center, and a speaker 215 for two-way voice communication with the call center and for an alert device as described more fully below. In one embodiment, the short-range wireless transceiver module 220 uses micro circuitry to generate standard ZigBee protocol.

The activator 105 has a self-test button 235 used to initiate self-test method 540. The activator 105 has an emergency button 240 used to initiate emergency response method 530. The activator 105 optionally has a Tier 1 security button 245 used to initiate a Tier 1 security alert. A Tier 1 security alert is a security alert which requires response by an official agency such as the police where verification that the event is not a false alarm is important. The activator 105 has a finder button 250 used to initiate finding method 1100.

When any of buttons 235, 240, 245 or 250 are activated, the microprocessor 205 causes the transceiver 220 to signal the mobile base station 115 to transmit coded messages to the call center 130 as appropriate. The microprocessor 205 also controls routing of voice communications with the microphone 210 and the speaker 215 to the mobile base station 115 via the transceiver module 220. A user access event occurs when the user initiates communication through the activator, either by pressing any of buttons 235, 240, 245, or 250, or by speaking into the activator.

A battery 230 will power the activator 105. In one embodiment the battery 230 is a rechargeable battery which can be re-charged in a holder or with an external charger. In another embodiment, the activator battery 230 is not rechargeable. The activator 105 may also contain an alarm function to signal when the activator 105 is out of range from the mobile base station 115 or when the battery power is depleted. One alarm will be an audible alert from the speaker 215 that will sound periodically until the activator 105 re-establishes contact with the mobile base station 115. A separate alarm from the speaker 215 will indicate a low battery condition. The activator 105 may also contain an LED 255 that illuminates when at least one of buttons 235, 240 245 or 250 has been pressed. The activator 105 may also contain a display 260 for display of text or video.

The activator 105 may also contain a location system module 265 that will provide location and time data for the microprocessor 205 to route to revolving memory locations in memory 225. After processing the location and time information and checking for errors, the microprocessor 205 will store the data in memory 225. If the location data is determined to be corrupt, the last good location data will be saved. Upon program time out, the microprocessor 205 will assemble the location information in a message request and send the request to the mobile base station 115 for transmission over the communications network 125 to the call center 130.

The activator 105 may also contain a beacon module 270 for locating the activator using method 688.

FIG. 3 is a block diagram showing the mobile base station 115. In one embodiment, the mobile base station 115 is a small PDA size device. The control microprocessor 305 is programmed to handle verification test, external programming, over the air programming, message generation/storage including SMS messages, event timing, and interface to the short-range wireless communications transceiver module 310 and long-range communications transceiver module 330. The control microprocessor 305 may support Network initiated Over-The-Air Parameter Administration (OTAPA) and Over-The-Air Service Provisioning (OTASP) to fine-tune system performance and remote subscriber provisioning. The control microprocessor 305 also contains independent identification information for the mobile base station 115. In one embodiment, the identification information is determined using the ANI (Automatic Number Identification) system.

The mobile base station 115 communicates with the activator 105 through the short-range wireless communications module 310 to respond to control, test, find and voice message communications. Short-range wireless communications module 310 may be a Bluetooth or WiFi device or other advanced short-range broadband communications device. In one embodiment, the mobile base station 115 communicates with the activator 105 using the ZigBee protocol. The mobile base station 115 contains an LED 320 that illuminates during any communication with the activator 105.

The mobile base station 115 communicates with the call center 130 through the long-range communications transceiver module 330 over the communications network 125. In one embodiment, the long-range communications transceiver module 330 is a CDMA or GSM phone with included antennas designed to work with the communications network 125 and communicate with the call center 130. In other embodiments, the long-range communications transceiver module 330 may be a satellite communications unit, WiMAX, WiFi, or other advanced broadband/narrowband communications device. In another embodiment the long-range communications transceiver module 330 may be a software-defined radio with capabilities to adapt to future and existing wireless communications technologies. The long-range communications transceiver module 330 may also be or include a POTS autodialer for applications where wireless does not work or for backup purposes. In one embodiment, the autodial function will be implemented through V.70 equipment to support simultaneous voice and data over POTS.

The control button 322 is used to initiate alarms from the mobile base station 115 as if they were initiated from the activator 105. The Tier I security button 323 is used to initiate a Tier I security alert described above from the mobile base station 115. The emergency button 324 may be used to initiate emergency response method 530 from the mobile base station 115. The beacon button 325 is used to initiate location of the activator 105 through the beacon module 370 using method 688. The finder button 328 may be used to locate the activator 105 using finding method 1100. The speaker 375 provides an audible signal used in finding method 1100 when the user is locating the mobile base station 115. In one embodiment, the speaker 375 and the microphone 380 are contained in the long-range communications module 330. The external programming interface 365 may be used to provide new program information to the control microprocessor 305.

The location system module 340 provides location input used in methods 530 and 540. In one embodiment, the location system module 340 provides location input using the U.S. Government's GPS (Global Positioning System) satellite system. In another embodiment, the location system module 340 may provide location input using the network based location services associated with the long-range communications transceiver module 330. In another embodiment, when the activator 105 contains a location system module 265, the location system module 340 may be omitted from the mobile base station 115. The mobile base station 115 retains the latest location coordinate set meeting programmed specifications stored in memory 360 until a new set of coordinates is acquired. The new set of coordinates is only stored in memory 360 if they are determined to be of sufficient quality and not corrupted. The latest location coordinates acquired before entry into a building or other environment with inadequate external location system reception are therefore saved and used for location determination.

The battery 350 is internal to the unit. In one embodiment the battery 350 will be a LiOH battery that can be recharged from standard electrical AC power using the external power supply and charger 355. In another embodiment the mobile base station 115 is operated from a vehicle battery using the cigar lighter accessory connector or other convenient connection. The vehicle power may also be used to charge the battery 350. In another embodiment the battery 350 is a non-rechargeable battery.

The memory 360 is solid state and nonvolatile and stores the program, user ID, location coordinates, and voice test messages and prompts.

FIG. 4 is a block diagram showing the external components 120, including the communications network 125 and the call center 130. Call center 130 is a modern functional telecom call center facility equipped with call center operator stations 135, processors and databases for receiving emergency and test calls from a plurality of mobile base stations. The call center 130 also is equipped with voice quality testing capability 140. The call center 130 may have capabilities for any combination of: 1) storing text messages containing location parameters, time, messages from mobile base stations, 2) receiving and recording voice calls from users, 3) routing any received messages to appropriate work stations based on the user ID of the incoming call for further processing and display, and 4) routing voice calls to the corresponding work stations for operator action. The call center 130 will also have telephone capabilities for placing calls to the user using telco interface 480 with either a wireline communications service 460 or a wireless communications service 470.

The call center computer telephony integration (CTI) device will handle operator scripts and associate the received data with map location and physical addresses. The database will also indicate what emergency district the caller is calling from in order to coordinate responses with emergency and security responders. The call center 130 receives alert messages from mobile base stations 115 and routes the response call to the appropriate operator based on prearranged processes keyed to the originating mobile base station. Call center operators will be equipped with software and hardware displays to identify the user and show graphically where the user is located during the emergency call session. The operators may conduct one-way or two-way voice communication with the user via an activator 105. All aspects of the emergency and routine calls will be recorded, including the voice records, for legal purposes.

In one embodiment, the call center 130 is a network of call centers with ability to confer and conference events in different geographic areas. In one embodiment, each individual call center has specialized capabilities. The call center 130 may also have special network provisions for connecting with national emergency databases 410 such as the Centers for Disease Control and Prevention, the National Institutes of Health, or the national poison control center. Information dialogues and database exchanges would be possible through this expanded interface. In one embodiment, the call center 130 includes the ability to transfer, conference, or hand off calls from the user to an FCC registered Public Safety Answering Point (PSAP), Emergency Medical Services, police or 911 services as shown in 440. The call center 130 may communicate with the national emergency databases through the internet 420 or the Public Switched Telephone Network (PSTN) 430. In one embodiment, the wireline communications service 460 and the wireless communications service 470 are the PSTN 430.

FIG. 5 is a flow chart depicting a method 500 for personal emergency response in accordance with certain exemplary embodiments. The exemplary method 500 is illustrative and, in alternative embodiments of the invention, certain steps can be performed in a different order, in parallel with one another, or omitted entirely, and/or certain additional steps can be performed without departing from the scope and spirit of the invention. The exemplary method 500 is described below with reference to FIGS. 1-5.

In step 510, the activator 105 signals the mobile base station 115 with a voice and/or data alert request over the short-range reverse path 112. In step 515, the mobile base station 115 acquires and verifies the user ID of the activator 105. Verification is important because mobile base stations may communicate with multiple activators. In one embodiment, one mobile base station 115 supports multiple activators 105 individually associated with multiple users living in a single dwelling. Activators 105 can also communicate with multiple mobile base stations 115. In one embodiment, mobile base stations 115 are strategically placed throughout a campus environment and each activator 105 communicates with the nearest mobile base station 115. In step 520 the mobile base station 115 determines whether the alert signal is for a system test or for an emergency response. If the alert signal is for a system test, method 540 described below occurs. If the alert signal is for an emergency response, method 530 described below occurs. After the completion of either method 530 or method 540, the method 500 for personal emergency response ends.

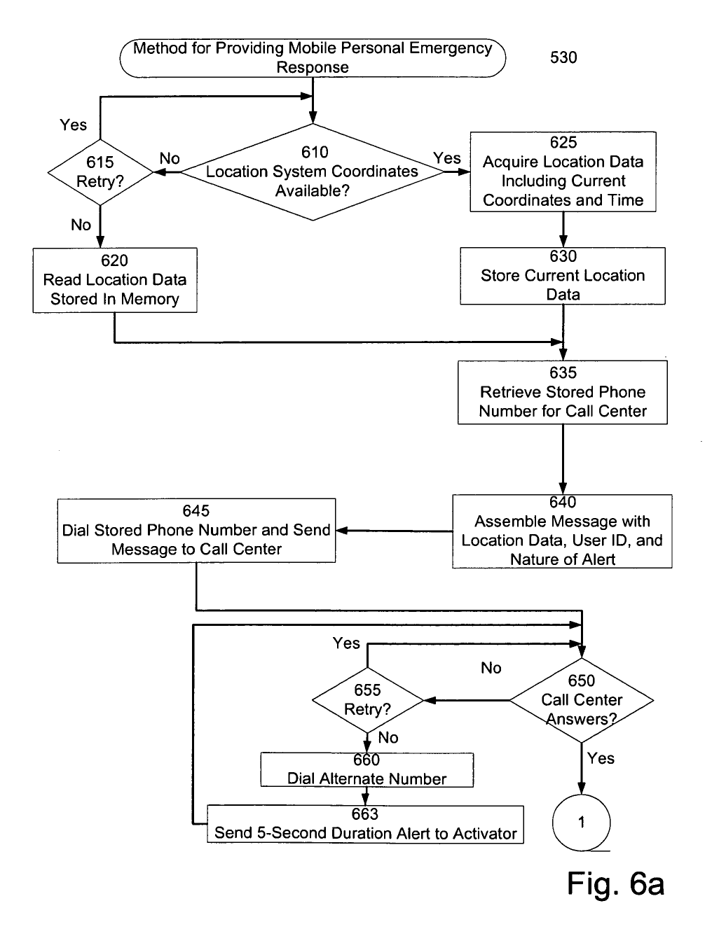

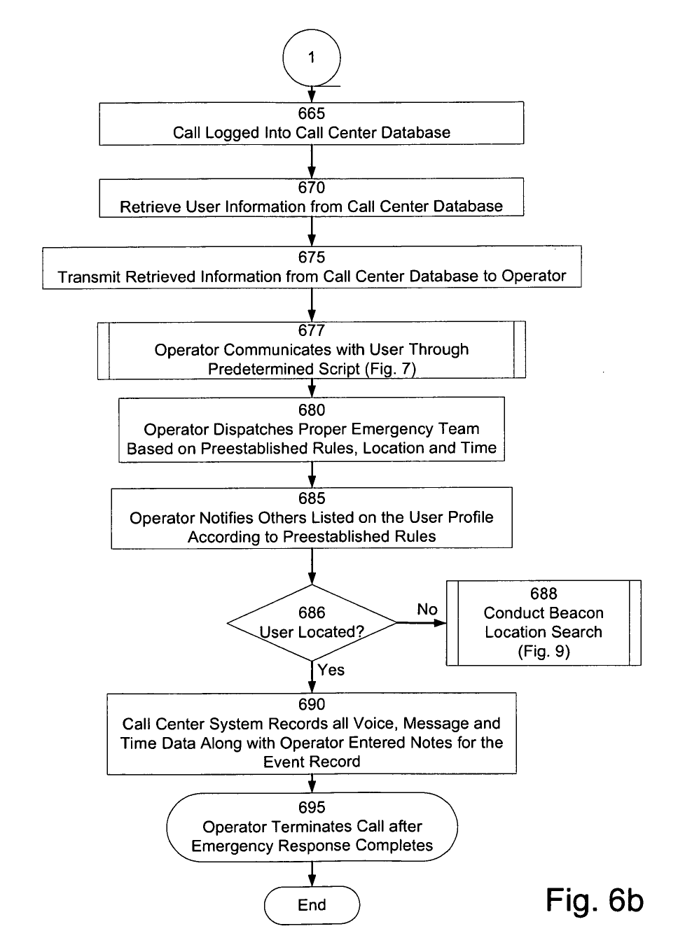

FIGS. 6a and 6b, collectively described as FIG. 6, are flow charts depicting a method 530 for providing a mobile personal emergency response as referred to in step 530 of FIG. 5. The exemplary method 530 is illustrative and, in alternative embodiments of the invention, certain steps can be performed in a different order, in parallel with one another, or omitted entirely, and/or certain additional steps can be performed without departing from the scope and spirit of the invention. The exemplary method 530 is described below with reference to FIGS. 1-4 and FIG. 6.

In step 610, the mobile base station 115 determines whether current coordinates are available from the external location system 110. If current coordinates are not available, in step 615 the mobile base station 115 retries acquiring current coordinates for a predetermined number of times. If that number of times is exceeded, in step 620 the mobile base station 115 reads the location data that is stored in memory 360 and proceeds to step 635 defined below. If current coordinates are available, in step 625 the mobile base station 115 acquires the current coordinates. In step 630 the mobile base station 115 stores the current coordinates in memory 360.

In step 635, the mobile base station 115 retrieves the stored phone number for the call center 130. In step 640, the mobile base station 115 assembles a message including the current coordinates, the user ID and the nature of the alert. In one embodiment, the message is an SMS message. In step 645, the mobile base station 115 dials the stored phone number and sends the message to the call center 130 through the communications network 125 long-range reverse path.

In step 650, the mobile base station 115 determines whether the call center 130 has answered the call. If the call center 130 did not answer, in step 655 the mobile base station 115 retries the stored phone number for a predetermined number of times. Once that number of times has been exceeded, in step 660 the mobile base station dials an alternate number stored in memory 360. In step 663 the mobile base station 115 sends an alert to the activator 105 so that the user is aware the mobile base station 115 has proceeded to an alternate number. Steps 655 through 663 repeat until the call center 130 answers.

In step 665, the call is logged into the call center database. In step 670, user information is retrieved from the call center database based on the information transmitted in the message from mobile base station 115. In step 675, user information is transmitted from the call center database to the call center operator. User information may include items such as predetermined rules on which emergency responders to dispatch, additional conditions associated with a particular user, a voice recording made by the user, or other parties to be notified in the event of an emergency. For example, a user may call and leave information to be used in the event of an emergency call such as a real estate agent recording a particular location destination within a high-rise building together with the identity and a description of the person she is planning to meet and that person's vehicle. Users would record information such as who they are meeting, where they are going, when and for how long they intend to be there, and any other information that might be helpful in the event an emergency response is required. In step 677, which is described more fully below, the operator communicates with the user through a predetermined script.

In step 680, the call center operator dispatches the proper emergency response team based on predetermined rules from the call center database, the user location information transmitted in the message from mobile base station 115, and the time. In step 685, the operator notifies any other parties listed on the user information to be notified in the event of an emergency according to predetermined rules retrieved from the call center database. Notification may be via e-mail, text message, SMS message, voice call, pager, or other communication method.

In step 686, the call center operator is notified whether the user has been located by the emergency responder. If the user has not been located, the beacon location search is made using method 688 described more fully below. If the user is located, in step 690, the call center 130 records all voice, message and time data together with any notes entered by the operator into an event record in the call center database. In step 695, the operator terminates the call after the emergency response completes. When the emergency response is completed, method 530 ends.

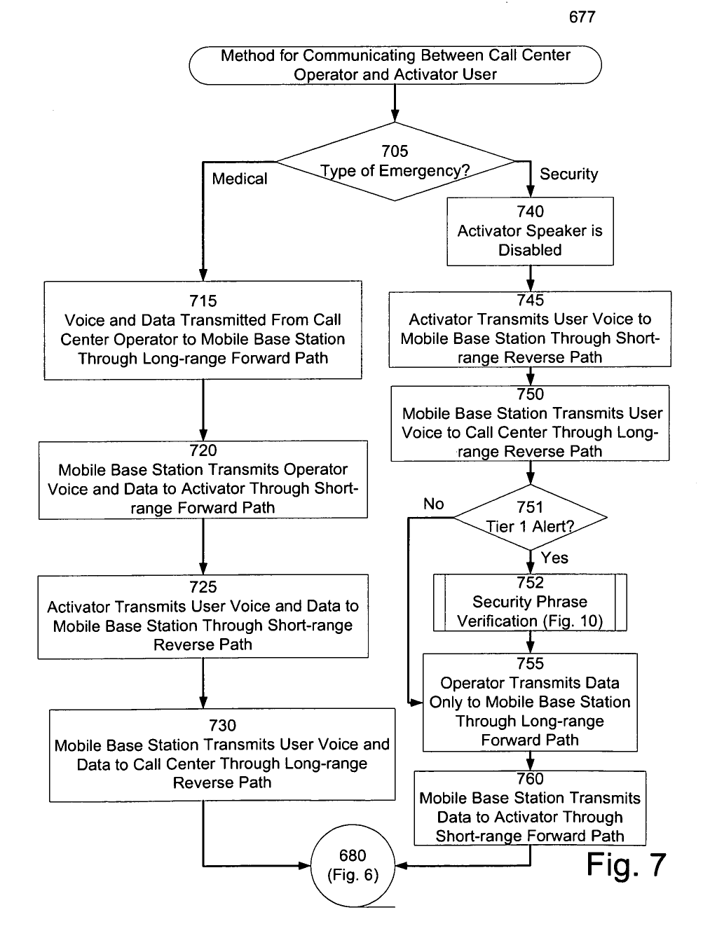

FIG. 7 is a flow chart depicting a method 677 for communication between a call center operator and an activator user as referred to in step 677 of FIG. 6. The exemplary method 677 is illustrative and, in alternative embodiments of the invention, certain steps can be performed in a different order, in parallel with one another, or omitted entirely, and/or certain additional steps can be performed without departing from the scope and spirit of the invention. The exemplary method 677 is described below with reference to FIGS. 1-4 and FIG. 7.

In step 705, a determination is made as to whether the alert is a medical or security alert using information sent from the mobile base station 115. If the alert is a medical alert, in step 715 voice and data communications are transmitted from the call center operator to the mobile base station 115 through the communications network 125 on the long-range forward path. In step 720, the mobile base station 115 transmits the received voice and data communications to the activator 105 through the short-range forward path 108. In step 725, the activator 105 transmits user voice and data communications through the short-range reverse path 112 to the mobile base station 115. In step 730, the mobile base station 115 transmits the user voice and data communications to the call center operator through the communications network 125 on the long-range reverse path. Steps 715-730 repeat as required for all communications between the call center operator and the user to complete. In one embodiment voice and data are transmitted simultaneously.

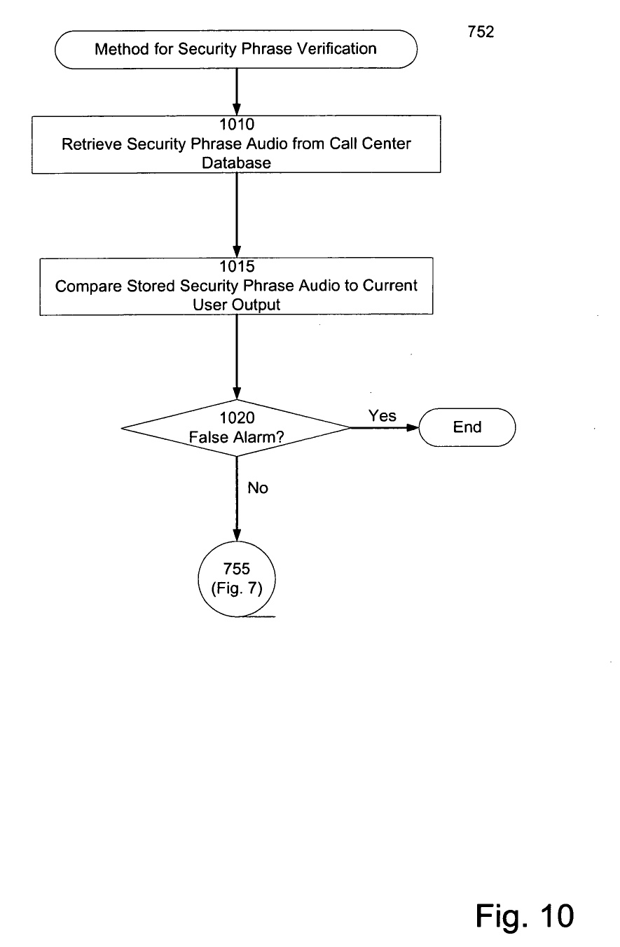

If in step 705 the alert is determined to be a security alert, where two-way voice communication would jeopardize the user's safety, in step 740 the activator speaker 215 is disabled. In step 745, the activator 105 transmits voice through the microphone 210 to the mobile base station 115 using the short-range reverse path 112. In step 750, the mobile base station 115 transmits voice to the call center operator using the communications network 125 long-range reverse path so the operator and any emergency responders can hear what is occurring at the user's location. In step 751 the type of security alert is determined using the information sent from the mobile base station 115. If the alert is a Tier I security alert, where response is required from authorities such as the police, step 752 occurs. In step 752, described more fully below in FIG. 10, security phrase verification is used to confirm that the security alert is not a false alarm. If the alert is a Tier II security alert, where response is required from private individuals previously identified by the user, step 755 occurs. In step 755, the call center operator returns data only to mobile base station 115 through the communications network 125 on the long-range forward path. In step 760, the mobile base station 115 transmits data only to the activator 105 using the short-range forward path 108. In one embodiment, the data transmitted would be a signal causing LED 255 to illuminate so that the user has confidence the call center received the alert. In another embodiment, the data would be a text message shown on display 260.

Once the communication between the call center operator and the user is completed, the method 677 continues to step 680 depicted in FIG. 6.

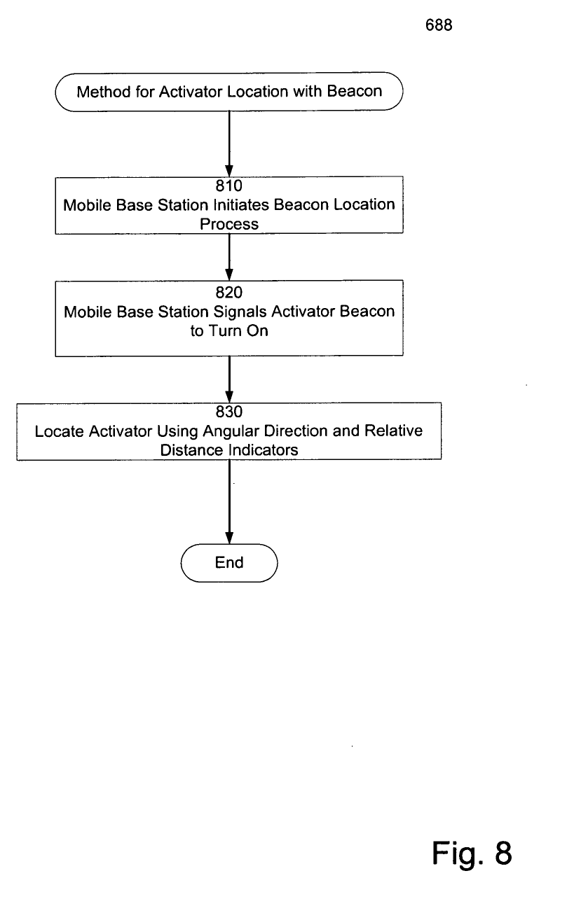

FIG. 8 is a flow chart depicting a method 688 for locating the activator using a local beacon as referred to in step 688 of FIG. 6. The exemplary method 688 is illustrative and, in alternative embodiments of the invention, certain steps can be performed in a different order, in parallel with one another, or omitted entirely, and/or certain additional steps can be performed without departing from the scope and spirit of the invention. The exemplary method 688 is described below with reference to FIGS. 1-3 and FIG. 8.

When the emergency response personnel cannot locate the user, but can locate the mobile base station 115, in step 810 the emergency response personnel press beacon button 325. In step 820, the mobile base station 115 signals beacon module 270 in the activator 105 to turn on and commands the mobile base station beacon module 370 to switch to directional mode. In step 830, the mobile base station 115 indicates the angular direction of and relative distance away from activator 105. Two or three measurements from different angles will allow the emergency response personnel to pinpoint the location of the activator 105. Exemplary embodiments of indications from the mobile base station 115 include 1) flashing of LED 320 to indicate that the beacon has been detected, 2) color and/or intensity indication from LED 320 to indicate a direction locating null, and/or 3) a steady/varying tone from speaker 375. In one embodiment, beacon signaling between mobile base station 115 and activator 105 is accomplished using the ZigBee protocol. In another embodiment, emergency responders can use a direction finding Yagi antenna and special test equipment to more accurately locate the activator 105 through beacon module 270. Once the activator has been located, method 688 ends.

In one embodiment, automatic location of devices in a building or local area such as an apartment complex, a college or business campus, or a medical center, is accomplished using fixed reference nodes placed in known positions. As an example of a commercially available OEM offering for this capability, the Texas Instruments CC2430/2431 ZigBee system on chip (SOC) may be used to create the reference nodes. Each reference node would be configured with the CC2430/2431 chip and would operate independently of each other node but all the nodes will be in communication with each other thereby forming a mesh network. In one embodiment, the reference nodes are co-located with the Exit signs in a building. Because AC power to the Exit signs will be on emergency power, and because the nodes will be powered from these sources, the beacons will be available even upon loss of normal power. In addition, the batteries in the Exit signs will also be available to provide power to the CC2430/2431 chip based equipment even in the event of loss of emergency power.

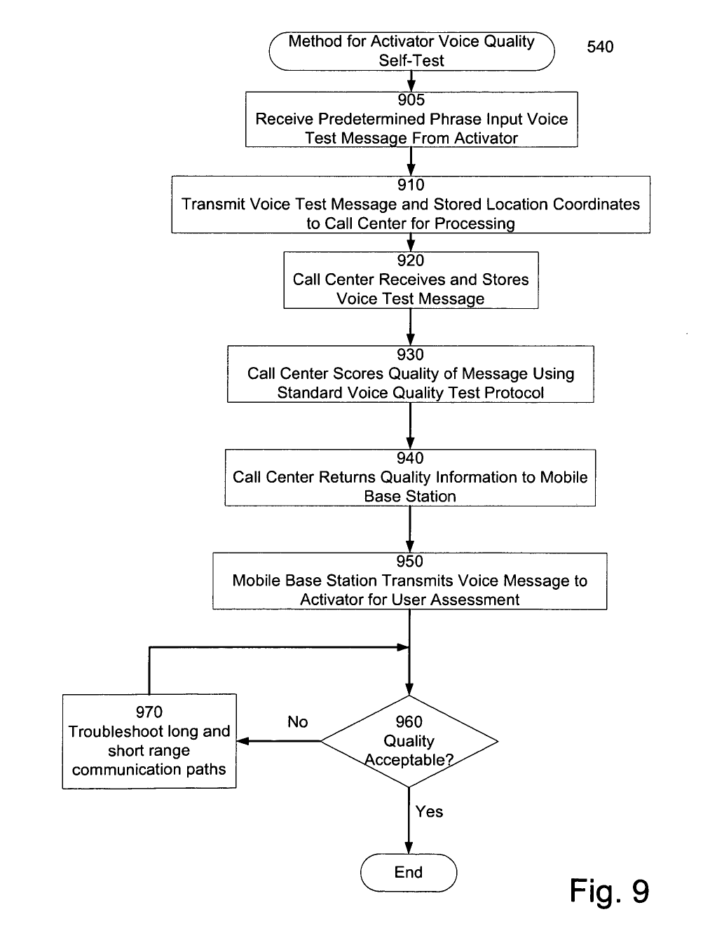

FIG. 9 is a flow chart depicting a method 540 for activator voice quality self-test as referred to in step 540 of FIG. 5. The exemplary method 540 is illustrative and, in alternative embodiments of the invention, certain steps can be performed in a different order, in parallel with one another, or omitted entirely, and/or certain additional steps can be performed without departing from the scope and spirit of the invention. The exemplary method 540 is described below with reference to FIGS. 1-4 and FIG. 9.

In step 905, the mobile base station 115 receives a predetermined phrase voice test message spoken by the user from the activator 105 on the short-range reverse path 112. The predetermined phrase is selected to have appropriate characteristics supporting a robust self-test function such as length, to avoid accidental truncation, and particular phonemes that test voice quality. In step 910, the mobile base station 115 transmits the voice test message and stored location coordinates through the communications network 125 on the long-range reverse path to the call center 130 for processing. In step 920, the call center 130 receives and stores the voice test message and location coordinates in the call center database. This information may be accessed as required for post-test review to correct or optimize the system

In step 930, the call center 130 scores the quality of the message using standard voice quality test protocol. In one embodiment, the scoring is done by automated test processors that rate the quality of the user's message from 1 to 5 using a standard test protocol such as PAMS (Perceptual Analysis/Measurement System). In step 940, the voice message and quality information are returned from the call center 130 to the mobile base station 115 through the communications network 125 using the long-range forward path. In step 950 the mobile base station 115 transmits the voice message back to the activator 105 over using the short-range forward path 108 for user assessment. The subjective view of the voice quality together with the objective test performed with the processing power at the call center 130 provides a robust assessment of the voice performance of the system and helps pinpoint the location of any voice transmission problem to either the long-range or short-range paths. In one embodiment, RSSI values from the sending and receiving ends will be measured and recorded at the call center 130 for additional information to support the voice test assessment for call center technical review. In one embodiment, the call center also returns a resolved address for the user's location coordinates allowing the user to correct any mismatches between the measured location coordinates and the resolved address.

In step 960, the user determines whether the quality of the returned message is available. If it was not, in step 970 troubleshooting of the short-range and long-range paths pinpoints the problem for correction. When the quality of the voice test message is acceptable, method 540 ends.

FIG. 10 is a flow chart depicting a method 752 for security phrase verification during a Tier I security alert as described above in step 752. The exemplary method 752 is illustrative and, in alternative embodiments of the invention, certain steps can be performed in a different order, in parallel with one another, or omitted entirely, and/or certain additional steps can be performed without departing from the scope and spirit of the invention. The exemplary method 752 is described below with reference to FIGS. 1-4 and FIG. 10.

In step 1010, stored security phrase audio spoken by the user is retrieved from the call center database. In step 1015, the call center operator compares the stored security phrase audio to the current user output transmitted from the activator 105 through the microphone 215. Comparisons may be made using either objective automatic comparisons or using the subjective judgment of the call center operator. Comparisons may also be made using both objective and subjective tests. In step 1020, the operator determines whether the security alert is a false alarm through the comparison of current user output with the stored security phrase. If the security alert is a false alarm, method 752 terminates. If the security alert is not a false alarm, method 752 returns to step 755 of FIG. 7 discussed above.

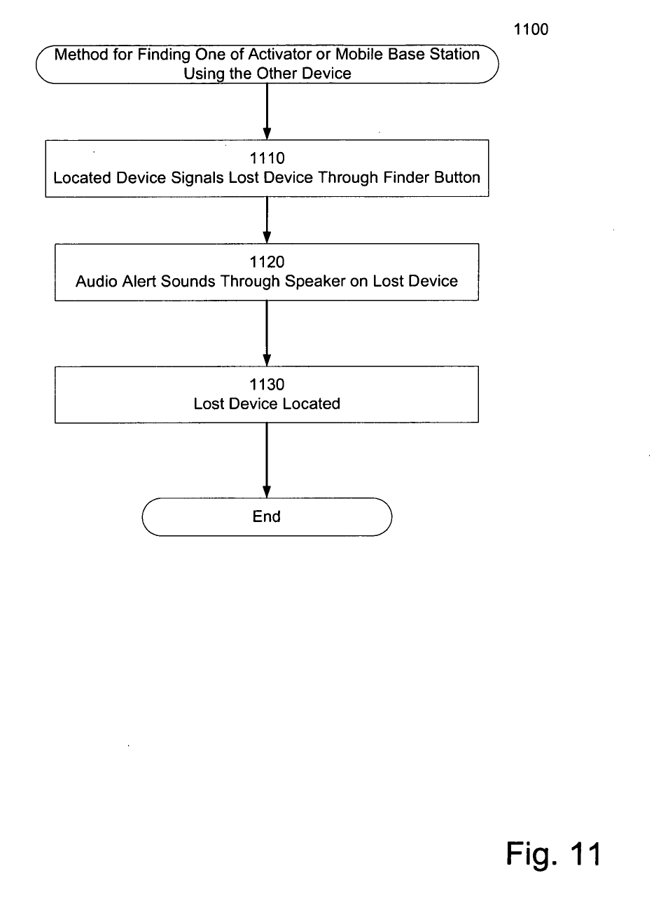

FIG. 11 is a flow chart depicting a method 1100 for locating one of the activator 105 or mobile base station 115 using the other device. The exemplary method 1100 is illustrative and, in alternative embodiments of the invention, certain steps can be performed in a different order, in parallel with one another, or omitted entirely, and/or certain additional steps can be performed without departing from the scope and spirit of the invention. The exemplary method 1100 is described below with reference to FIGS. 1-3 and FIG. 11.

When one of the mobile base station 115 or activator 105 is lost, in step 1110 the known device signals the lost device through either finder button 250 (when the activator is the known device) or finder button 328 (when the mobile base station is the known device). In step 1120, an audio alert sounds through the speaker on the lost device: speaker 375 when the mobile base station is the lost device or speaker 215 when the activator is the lost device. The user may repeat steps 1110-1120 as required. In step 1130, the lost device is located through the audio alert. As an example, if the mobile base station is misplaced in the user's vehicle, the user can locate the device from the sound. Once the lost device is located, method 1100 ends.

It will be appreciated that the exemplary embodiments of the invention overcome the limitations of the prior art. From the description of the exemplary embodiments, equivalents of the elements shown therein and ways of constructing other embodiments of the invention will be apparent to practitioners of the art. Many other modifications, features and embodiments of the invention will become evident to those of skill in the art. It should be appreciated, therefore, that many aspects of the invention were described above by way of example only and are not intended as required or essential elements of the invention unless explicitly stated otherwise. Accordingly, it should be understood that the foregoing relates only to certain embodiments of the invention and that numerous changes can be made therein without departing from the spirit and scope of the invention.

We claim:

1. A mobile personal emergency response system, comprising:
(a) a mobile base station, comprising:
a short-range transceiver, coupled to a wireless, bi-directional short-range communication network, for transmitting a short-range forward path signal and receiving a short-range reverse path signal,
a long-range transceiver, coupled to a bi-directional, long-range communications network, for transmitting a long-range reverse path signal and receiving a long-range forward path signal,
a location system module for obtaining location coordinates associated with a position of the mobile base station from one of an external source and memory, the location system module operative to obtain the location coordinates from memory only if the external source is not accessible or the current location coordinates are determined to be corrupted after a predetermined number of attempts, and
a processor for controlling operations by the short- and long-range transceivers and the location system module;
(b) a user-accessed, portable activator operative to communicate voice and data content with the mobile base station when the activator is operating in range of the short-range communication network, the activator comprising a short-range transceiver, coupled to the short-range wireless communication network, for receiving the short-range forward path signal from the mobile base station and transmitting the short-range reverse path signal to the mobile base station, the transceiver operative to transmit the short-range reverse path signal in response to a user access event,
wherein the voice and data content of the short-range forward path signal comprises at least a portion of the voice and data content obtained from the long-range forward path signal and at least a portion of the voice and data content of the long-range reverse path signal comprises the voice and data content obtained from the short-range reverse path signal and the location coordinates associated with a position of the mobile base station.
